(19) United States
(12) Patent Application Publication
(10) Pub. No.: US 2005/0167969 A1
(43) Pub. Date: Aug. 4, 2005

(54) Structure of main frame for construction machines and method of manufacturing the same

(76) Inventors: Kazumasa Fukazawa, Chattanooga, TN (US); David Andrews, Hixon, TN (US); Masayuki Mukaino, Chattanooga, TN (US)

Correspondence Address: VARNDELL & VARNDELL, PLLC, 106-A S. COLUMBUS ST., ALEXANDRIA, VA, 22314, US

(21) Appl. No.: 10/766,470

(22) Filed: Jan. 29, 2004

(51) Int. Cl. B62D 21/12

(52) U.S. Cl. 280/785

(57) ABSTRACT

A structure of a main frame of a construction machine and a method for manufacturing the same are invented. Portions of the main frame to which an external force is applied by traveling units and working machines are formed into unitary casting modules, and the other portions of the main frame are formed into modules of sheeted structures. Then, these modules are combined to form the main frame. In the manufacturing process, required machining operations for the modules are completed before the combining of the same modules together.

### BACKGROUND OF THE INVENTION

1. Field of the Invention

This invention relates to a structure of a main frame for construction machines, and a method of manufacturing the same.

2. Description of Related Art

In general, a construction machine is basically formed by providing a longitudinally elongated, upper coverless, substantially box type main frame in a central portion of a vehicle, attaching traveling units to left and right sides of the main frame, attaching a working machine to a front portion and/or a rear portion of the main frame, and further providing a power component, such as an engine, a transmission, a hydraulic pump and the like in an inner space of the main frame.

As known well, in a construction machine, the power of a working machine can be displayed owing to the longitudinal and lateral stability obtained by the straddling of the traveling units attached to the construction machine, and the traction obtained by the same traveling units. The construction machine also receives a reaction force from the working machine.

As a result, a large external force is applied to the main frame by both the traveling units and working machine, so that the main frame demands a strength high enough to withstand the external force. On the other hand, the main frame demands that an inner space capable of holding an engine and power components therein be secured on the inner side thereof. Developing a structure of a main frame meeting both of these demands has become a problem to be solved.

Various kinds of structures of the main frame have been devised for the purpose of solving this problem. The patent literature 1 discloses as a first example a structure for improving the strength of the portions of a main frame in a bulldozer to which traveling units are attached. The patent literature 2 discloses as a second example a structure for improving the strength of the portion of a main frame to which a working machine is attached, of a bulldozer taken as an example.

First and second examples of a related art main frame of a construction machine will now be described in detail with reference to FIGS. 6A and 6B and FIG. 7 taking as examples the structures disclosed in the above patent literature 1 and patent literature 2.

First, the first example of the related art structure of a main frame for construction machines will be described with reference to FIGS. 6A and 6B.

FIGS. 6A and 6B are perspective view describing the first example of the related art main frame for construction machines, in which FIG. 6A is a drawing describing a basic shape; and FIG. 6B a drawing describing an applied shape.

Referring to FIG. 6A, a main frame 80 is formed by front and rear side plates 82a, 82b, 83a, 83b, a bottom plate 84, a rear plate 85, and one front crossbar 86 and one rear crossbar 87. The crossbar 86 is formed to a length large enough to permit the crossbar 86 to be passed through the front side plates 82a, 82b and project outward laterally from a front portion of a track frame 88 of a traveling unit (not shown) This crossbar 86 is fixed in the track frame 88 by using halved caps 90, 90, a plate 92 and a bolt 93. A rear crossbar 87 is formed to a length large enough to permit the rear crossbar 87 to be passed through the rear side plates 83a, 83b and project outward laterally from a rear portion of the track frame 88. This crossbar 87 is fixed to a lower stepped portion 88a at a rear end of the same track frame 88 by using caps 94, 94.

A working machine (not shown) is fixed to F1, F2 portions at front ends of the front side plates 82a, 82b, while brackets (not shown) which support cylinders (not shown) for vertically swinging the working machine are fixed to G1, G2 portions.

Referring then to FIG. 6B, it is said to be possible as well to cut off a radiator guard 89 from the front side plates 82a, 82b, fix the front crossbar 86 to the radiator guard 89, and engage plates 96a fixed to the front crossbar 86 and plates 96b fixed to the front side plates 82a, 82b with each other, and combine the plates 96a, 96b together in one body by bolts 97.

In the structure of FIG. 6A, the track frame 88 is combined with the main frame 80 via the shafts 86, 87. It is said to be possible to thereby join the track frame 88 with a cover 88b combined therewith to the main frame 80 in one body, discharge easily in consequence the earth and sand collected on the track frame 88, and alleviate the stress concentration in and around the shafts 86, 87 owing to the combined portions formed by cross-sectional circular shafts 86, 87.

Referring then to FIG. 7, a second example of the related art main frame structure for a construction machine will be described.

FIG. 7 is a perspective view describing the second example of the related art main frame structure for a construction machine.

Referring to FIG. 7, a main frame 60 is formed by combining together lower end portions of left and right frames 61a, 61b, each of which is made of one straight plate, by a bottom plate 62, and fastening flanges 63a, 63b, which are fused to rear end portions of the frames 61a, 61b, to a front surface of a steering case 70 by bolts 71. Substantially central portions in the longitudinal direction of the frames 61a, 61b support an equalizer bar 79 by which track frames of left and right traveling units (not shown) are connected together so that the equalizer bar can be swung freely, a cross member 64 by which the left and right frames 61a, 61b are combined together being fused to the mentioned central portions thereof.

Hollow columnar members 65, 65 are fused in a vertically extending state to outer side surfaces of the portions of the left and right frames 61a, 61b which correspond to the position of the cross member 64 in side elevation. The hollow columnar members 65, 65 are provided at upper portions thereof with lift cylinder support members 66 fused thereto and adapted to support via pins 78 one end portion of the relative lift cylinders 77 adapted to vertically swing a working machine 75. A working machine support members 73, which are adapted to support the working machine 75 via pins 76, are fastened by a required number of bolts 72 to through holes 68a, 68b, 68c made in front surfaces of lower portions of the hollow columnar members 65, 65.

An external force applied by the working machine 75 and lift cylinders 77 in the structure of FIG. 7 to the main frame 60 is first transmitted to the hollow columnar members 65, 65. The external force transmitted to the hollow columnar members 65, 65 is transmitted in the form of low stress by the vertically elongated hollow columnar members 65, 65 to the cross member 64, left and right frames 61a, 61b and bottom plate 62. It is said that this enables each of the left and right frames 61a, 61b to be made of one straight plate, and the main frame structure to be simplified and weight-reduced.

[Patent Literature 1]

JP-UM-A-6-49284 (pages 8 to 10, FIG. 1, FIG. 4)

[Patent Literature 2]

Japanese Patent No. 2978894 (pages 4 to 6, FIG. 1)

However, the construction of the first and second examples of the related art main frame structure for a construction machine has the following problems.

(1) In the main frames 80, 60, many welded structures are used at the portions thereof to which the working machine and cylinders for vertically swinging the working machine are fastened and at the neighboring portions thereof. Namely, welded structures are used at the portions F1, F2, G1, G2 in the main frame 80 (FIG. 6A), and at the portions to which the lift cylinder support members 66 are fastened, at the hollow columnar members 65, 65 themselves, and at the portions of the hollow columnar members 65, 65 which are fastened to the main frame 60 in the main frame 60 (FIG. 7). As a result, when the external force applied by the working machine and cylinders for vertically swinging the working machine is transmitted to the side plates 82a, 82b, 83a, 83b (FIGS. 6A and 6B) or the frames 61a, 61b (FIG. 7), stress concentration occurs in each of the welded portions due to the external force. Therefore, it is highly possible that destruction progresses from the stress concentration portions. In view of this, the durability of these main frame structures is not high.

(2) The main frames 80 (FIG. 6A) and 60 (FIG. 7) are long and have complicated shapes, so that a large-sized welding jig and a large-sized machine tool are needed to secure predetermined levels of form accuracy and dimensional accuracy of the main frames 80, 60. This causes the manufacturing cost to increase.

(3) A part of each of the main frames 80, 60, i.e. the radiator guard 89 in the main frame 80 (FIG. 6B) and the steering case 70 in the main frame 60 (FIG. 7) are divided into elements and formed as a built-up type part for the purpose of facilitating the manufacturing of the main frame structure. However, divisional elements still have large sizes. Moreover, since the parts are divided into elements, it becomes necessary to machine assembling portions thereof. As a result, it becomes difficult to reduce the manufacturing cost.

### SUMMARY OF THE INVENTION

The present invention has been made with the inventor's attention paid to these problems, and has an object of providing a main frame structure for construction machines, having a main frame provided in a central portion of a vehicle so as to extend in the longitudinal direction thereof, traveling units attached to left and right sides of the main frame, and a working machine attached to a front portion and/or a rear portion of the main frame, wherein stress concentration does not occur, whereby a high durability is attained; and a method of manufacturing a main frame structure for construction machines, capable of manufacturing the main frame structures easily, whereby a low manufacturing cost is attained.

To achieve this object, a first aspect according to the invention provides a main frame structure for construction machines, having a main frame provided in a central portion of a vehicle so as to extend in the longitudinal direction thereof, traveling units attached to left and right sides of the main frame, and a working machine attached to a front portion and/or a rear portion of the main frame, wherein portions to which an external force is applied by the traveling unit and working machine are formed into unitary casting modules, the other portions being formed into sheeted modules, these modules being combined together to form a main frame.

According to the first aspect of the invention, for example, the portions at which the traveling units are fastened and portions at which the working machine and cylinders for swinging the working machine are fastened in a front section of the main frame are put together and formed into a unitary casting module, the portions to which the traveling units are fastened and portions to which the working machine is fastened in a rear section of the main frame are put together and formed into a unitary casting module, and the other portions of the main frame are formed into a sheeted module. When these modules are combined together to form a main frame, an external force applied by the traveling units and working machine to the main frame is scattered in the unitary casting module, and transmitted to the main frame as a whole. Therefore, stress concentration does not occur, and a main frame having a high durability can thereby be obtained.

A second aspect according to the invention provides a main frame structure for construction machines in accordance with the first aspect, wherein at least one module out of the modules constituting the main frame is formed so that the module can be selected from modules of a plurality of kinds of specifications, whereby a main frame of different specifications can be formed.

According to the second aspect of the invention, the following operation and effects can be obtained in addition to those of the first aspect of the invention.

(1) The main frame is formed by changing at least one of the modules constituting the main frame to a module of different specifications. Thus, a main frame of different specifications can be obtained easily.

(2) The results of (1) above show that a group of construction machines of, for example, identical basic specifications (which will hereinafter be referred to as a vehicle class) may have a main frame of a substantially equal strength. Therefore, it becomes possible to use each of the modules of the main frames of various specifications in common in a group of construction machines of an equal vehicle class. This enables the manufacturing cost to be reduced.

(3) The results of (1) show that a main frame of special specifications in little demand can also be obtained easily and inexpensively by changing a certain module only to a module of special specifications in the same manner.

A third aspect according to the invention provides a method of manufacturing a main frame structure for construction machines, having a main frame provided in a central portion of a vehicle so as to extend in the longitudinal direction thereof, traveling units attached to left and right sides of the main frame, and a working machine attached to a front portion and/or a rear portion of the main frame, wherein portions to which an external force is applied by the traveling units and working machine are formed into unitary casting modules, the other portions being formed into sheeted modules, each module being subjected separately to required machine work, these modules being combined together after the machine work has been completed, to obtain the object main frame.

According to the third aspect of the invention, when required machining work is carried out for each of comparatively small modules separately, it becomes possible to use a regular machining tool of a high universality. Moreover, it becomes possible to carry out the handling and setting of each module easily and speedily during the machine work. This enables a main frame of a greatly reduced manufacturing cost to be obtained.

A fourth aspect of the invention provides a method of manufacturing a main frame for construction machines in accordance with the third aspect of the invention, wherein at least one module out of the modules each of which has finished being subjected separately to required machine work is formed so that the module can be selected from modules of a plurality of kinds of specifications, whereby a main frame of different specifications can be manufactured.

According to the fourth aspect of the invention, the following operation and effect can be obtained in addition to those of the third aspect of the invention.

(1) It becomes possible to use in common each of the modules of the main frames of various specifications in, for example, a group of construction machines of an equal vehicle class, and, moreover, store temporarily such modules in a separate machining completed state.

(2) Owing to the results of (1) above, it becomes possible to manufacture ordered main frames of various specifications in the shortest period of time, and thereby reduce the term of manufacturing the main frames.

(3) Owing to the effects described in (1) and (2) above, it becomes possible to control the quantity of production of each module and the quantity of stock thereof, and this enables the quantity of preparation of each module to be minimized.

(4) Owing to the results of (3) above, it becomes possible to further reduce the main frame manufacturing cost.

(5) The main frames of special specifications in little demand can also be obtained speedily and inexpensively by replacing a certain module only with a module of special specifications.

Owing to these effects, it becomes possible to provide a main frame structure for construction machines which has a main frame provided in a central portion of a vehicle so as to extend in the longitudinal direction thereof, traveling units attached to left and right sides of the main frame, and a working machine attached to a front portion and/or a rear portion of the main frame, and which does not encounter the occurrence of stress concentration, so that a high durability is attained; and a method of manufacturing a main frame for construction machines which enables main frames to be manufactured easily and thereby attains a low manufacturing cost.

### BRIEF DESCRIPTION OF THE DRAWINGS

FIG. 1 is a side view of a bulldozer to which the main frame structure for construction machines and a method of manufacturing the same according to the present invention are applied.

FIG. 2 is a perspective view describing the main frame structure for construction machines and a method of manufacturing the same in the first mode of embodiment of the present invention.

FIG. 3 is a perspective view describing the main frame structure for construction machines and a method of manufacturing the same in the second mode of embodiment of the present invention.

FIG. 4 is a perspective view describing the main frame structure for construction machines and a method of manufacturing the same in the third mode of embodiment of the present invention.

FIG. 5 is a perspective view describing the main frame structure for construction machines and a method of manufacturing the same in the fourth mode of embodiment of the present invention.

FIGS. 6A and 6B are perspective views describing a first example of a related art main frame structure for construction machines.

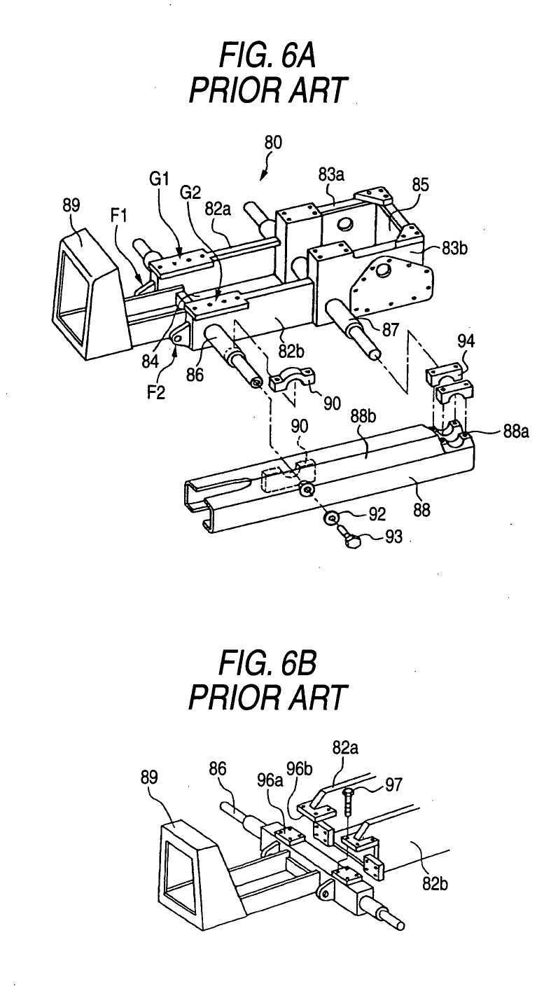

FIG. 7 is a perspective view describing a second example of a related art main frame structure for construction machines.

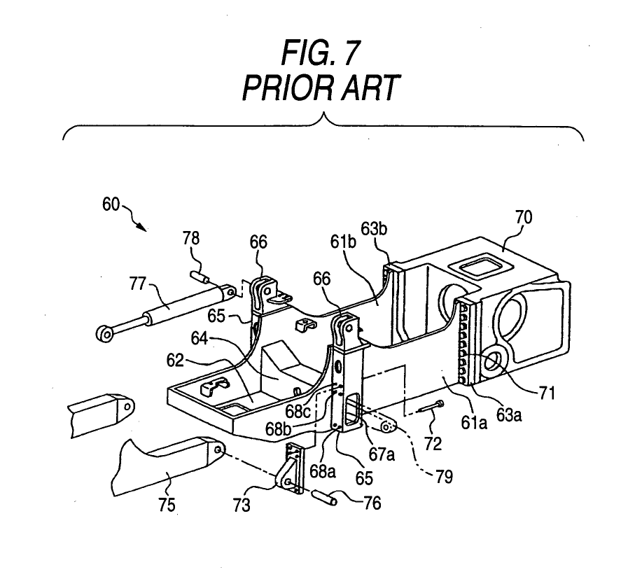

### DESCRIPTION OF PREFERRED EMBODIMENT

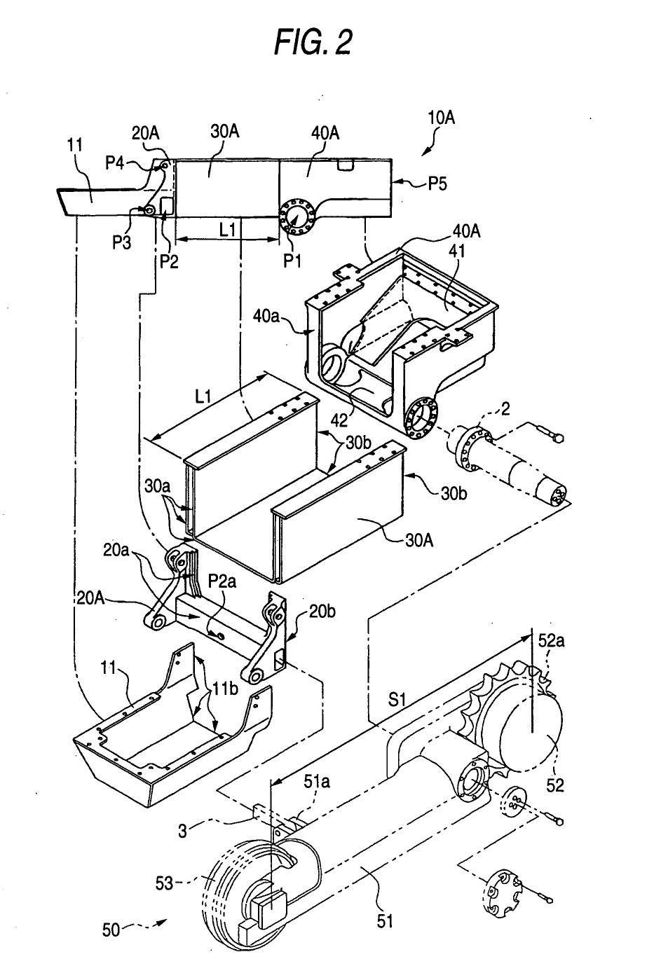

In the present invention, a main frame of a construction machine is prepared from a plurality of modules. These modules can be made from different specifications. The modules can be made or can have portions thereof made by casting, forging, welding of sheet metal, or a combination of these. For example, the Modules 20A and 40A as shown in FIG. 2 of the application can be made by metal casting. These or other portions of the main frame can be made from sheet metal and formed into a sheeted module, by welding the separate sheet metal parts together. The present invention is directed to a system of manufacturing construction machines including the preparation of a plurality of different modules, and selecting from the plurality of different modules those that are appropriate for a particular construction machine. The selected modules can be modified, if necessary, in order to adapt the selected modules for the construction machine under construction. The modules can be modified by machining, welding and/or other means known in the art. The selected modules are then combined together to form the main frame of the construction machine.

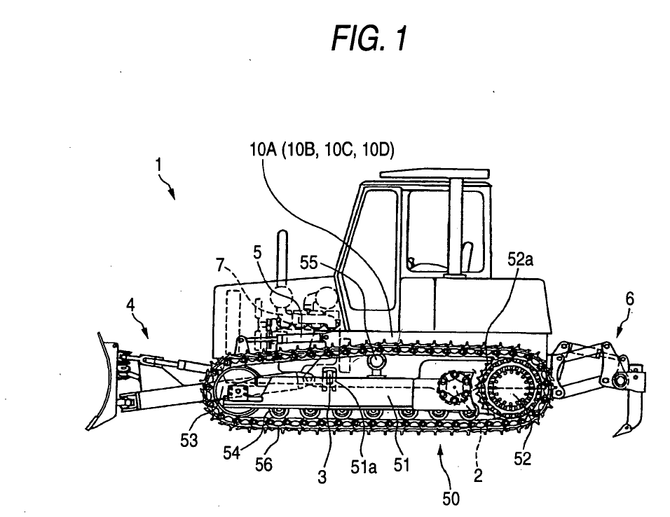

A first mode of embodiment to a fourth mode of embodiment of the main frame structure for construction machines and a method of manufacturing the same according to the present invention will now be described with reference to FIG. 1 to FIG. 5 with a bulldozer taken as an example to which the embodiments are applied.

First, a first mode of embodiment will be described with reference to FIG. 1 to FIG. 2.

FIG. 1 is a side view of a bulldozer to which the main frame structure for construction machines and method of manufacturing the same according to the present invention are applied, and FIG. 2 a perspective view describing the first mode of embodiment of the main frame structure for construction machines and method of manufacturing the same of the first mode of embodiment of the present invention.

First, referring to FIG. 1, a bulldozer 1 has any one of main frames 10A, 10B, 10C, and 10D in a central portion of the vehicle so as to extend in the longitudinal direction thereof, left and right traveling units 50 fixed pivotably to pivot shafts 2 projecting from left and right sides of the main frame, and link type equalizer bars 3, which connect together brackets 51a attached to front portions of the left and right traveling units 50, on which a front portion of the main frame 10A is placed. A working machine (which will hereinafter be referred to as a front working machine) 4 and a hydraulic cylinder 5 for vertically moving the front working machine 4 are fixed to a front portion of the main frame 10A, and a ripper (which will hereinafter be referred to as a rear working machine) 6 to a rear portion thereof. In addition, an engine 7 is placed on a front upper portion of the same main frame 10A.

Each traveling unit 50 includes a longitudinally elongated track frame 51, a sprocket 52a provided at the portion of the track frame 51 which is in the vicinity of a rear end thereof, an idler 53 provided at a front end portion of the track frame 51, a required number of track rollers 54 provided on a lower surface of the track frame 51, a required number of carrier rollers 55 provided on a substantially intermediate part of an upper portion of the track frame, and a crawler 56 wound around the sprocket 52a, idler 53, track rollers 54 and carrier rollers 55.

Referring then to FIG. 2, a P1 portion and a P2 portion of the main frame 10A constitute points of application of an external force applied by the traveling unit 50 to the main frame 10A owing to the construction described with reference to FIG. 1. Similarly, a portion P3 and a portion P4 of the main frame 10A constitute points of application of an external force applied by the front working machine to the main frame 10A, and a portion P5 a point of application of an external force applied by the rear working machine to the main frame 10A.

First, in the structure of the main frame 10A, the portions of the points P1, P5 of application of force are put together and formed into a unitary casting module 40A, and, similarly, the portions of the points P2, P3, P4 are put together and formed into a unitary casting module 20A, whereby the stress concentration in the vicinity of the points P1, P2, P3, P4, P5 of application of force is eliminated. The other portions are formed into sheeted modules 11, 30A. These modules 11, 20A, 30A, 40A are combined with one another by welding to form the main frame 10A.

Next, in the method of manufacturing the main frame 10A, each of the modules 11, 20A, 30A, 40A is subjected separately to required machine work. After the machine work is completed, these modules are combined together by welding so as to manufacture the main frame 10A. In order to facilitate the combining of the modules together, mutually contacting surfaces 11b, 20a; 20b, 30a; and 30b, 40a of the modules 11, 20A, 30A, 40A are formed so that these contact surfaces are engaged with a large area thereof respectively with one another. Thus, the form accuracy of the modules 11, 20A, 30A, 40A combined together by welding is secured easily. Moreover, increasing the areas of the mutually contacting surfaces of the modules 11, 20A, 30A, 40A has another object as well of lowering a load, i.e. stress per unit area of the portions to be combined together by welding.

In the above structure shown in FIG. 1 to FIG. 2, the portions having points P1, P2, P3, P4, P5 of application of external force applied to the main frame 10A are formed collectively into the unitary casting modules 20A, 40A, and the external force is thereby scattered in the same modules 20A, 40A, the resultant external force being thereafter transmitted to the main frame 10A as a whole. This enables the stress concentration to be eliminated. As a result, a main frame having a high durability can be formed.

In the main frame structure manufacturing method described above with reference to FIG. 1 to FIG. 2, machine work is carried out for each of the comparatively small modules 11, 20A, 30A, 40A separately. This enables the machine work to be executed by a regular machine tool of a high universality, the module handling and setting operations for the machine work to be done easily and speedily, and the main frame manufacturing cost to be thereby reduced greatly.

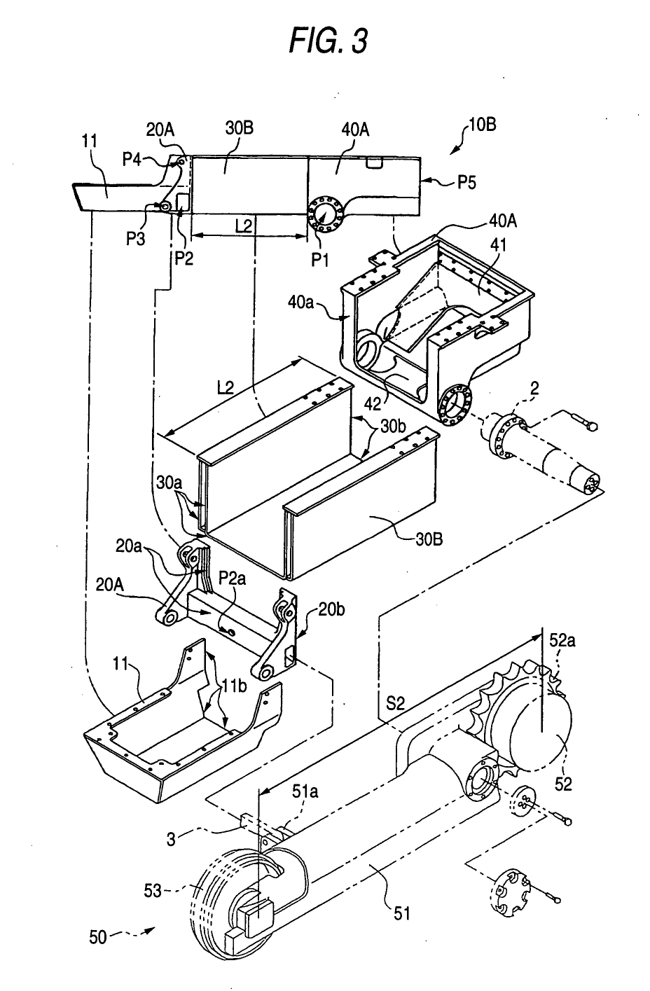

A second mode of embodiment will now be described with reference to FIG. 3.

FIG. 3 is a perspective view describing the construction of a main frame for construction machines in a second mode of embodiment of the present invention, and a method of manufacturing the same. The constituent elements of this embodiment identical with those of the embodiment of in FIG. 1 to FIG. 2 will be designated by the same reference numerals, and giving a description thereof in the paragraphs below will be omitted.

Referring to FIG. 3, a main frame 10B is applicable to a bulldozer 1 of the specifications in which a ground contact length S2 of a traveling unit 50 is larger than that S1 in the first mode of embodiment (FIG. 2). Among modules 11, 20A, 30B, 40A constituting the main frame 10B, a module 30B of a length L2 alone is substituted as an applied device for such a module 30A of a length L1 as in the first mode of embodiment (FIG. 2), and L2 is set longer than L1. This causes a position (position of a portion P2) of an equalizer bar to be shifted forward, so that the length of a forwardly projecting portion of the track frame 51 beyond the equalizer bar 3 does not increase. As a result, an increase in the load moment on the track frame is held down.

The method of manufacturing the main frame 10B is identical with that of manufacturing the already-described main frame 10A in the first mode of embodiment (FIG. 2).

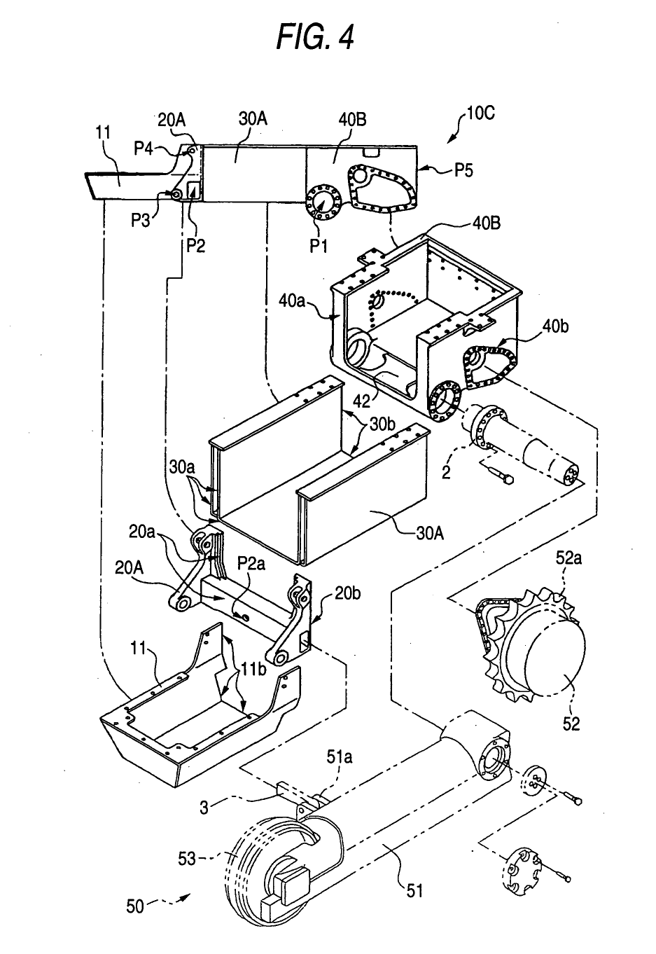

A third mode of embodiment will now be described with reference to FIG. 4.

FIG. 4 is a perspective view describing the construction of a main frame for construction machines in a third mode of embodiment of the present invention and a method of manufacturing the same. The constituent elements of this embodiment identical with those of the embodiment of FIG. 1 to FIG. 3 will be designated by the same reference numerals, and giving a description thereof in the paragraphs below will be omitted.

Referring to FIG. 4, a main frame 10C is applicable to a bulldozer 1 of the specifications in which final reduction gears 52 including sprockets 52a are attached to rear left and right portions of the main frame 10C. Among modules 11, 20A, 30A, 40B constituting the main frame 10C, the module 40B alone is substituted as an applied device for such a module 40A as in the first mode of embodiment (FIG. 2). The module 40B is provided at both side surfaces thereof with seat surfaces 40b to which the final reduction gears 52 are fixed.

A method of manufacturing the main frame 10C is identical with that of manufacturing the already-described main frame 10A in the first mode of embodiment (refer to FIG. 2).

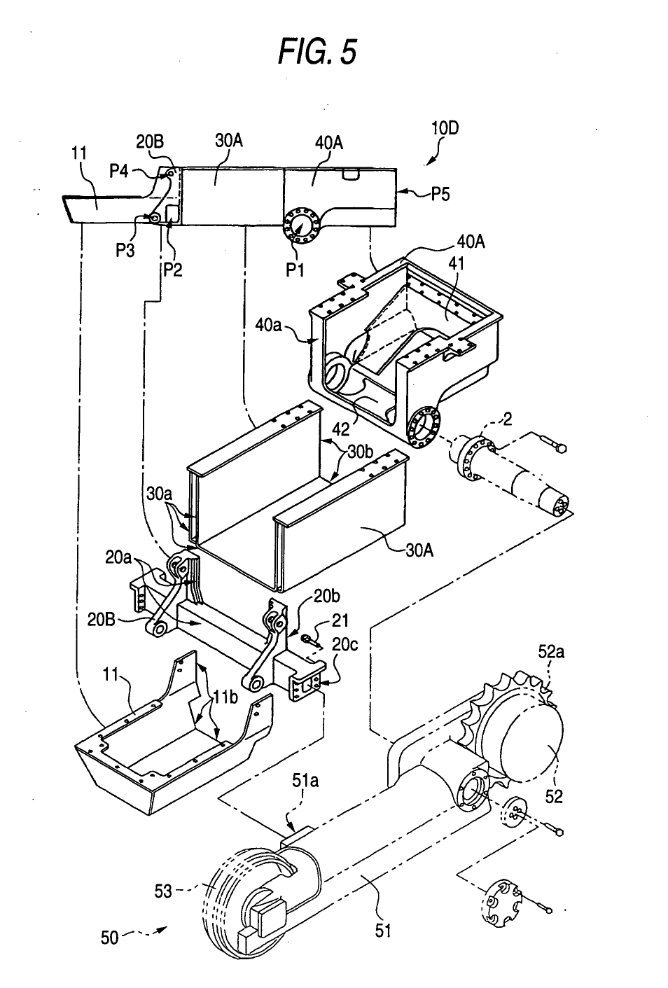

A fourth mode of embodiment will now be described with reference to FIG. 5.

FIG. 5 is a perspective view describing the construction of a main frame for construction machines in a fourth mode of embodiment of the present invention, and a method of manufacturing the same main frame. The constituent elements of this embodiment identical with those of the embodiments shown in FIG. 1 to FIG. 4 will be designated by the same reference numerals, and giving a description thereof in the paragraphs below will be omitted.

Referring to FIG. 5, a main frame 10D is applicable to a bulldozer 1 of the specifications in which a track frame 51 is fixed rigidly to the main frame 10D. Among modules 11, 20B, 30A, 40A constituting the main frame 10D, the module 20B alone is substituted as an applied device for such a module 20A as in the first mode of embodiment (FIG. 2). The module 20B is provided at left and right side portions thereof with seat surfaces 20c for attaching fixing surfaces 51b of front portions of track frames 51 thereto by a required number of bolts 21.

A method of manufacturing this main frame 10D is identical with that of manufacturing the already-described main frame 10A of the first mode of embodiment (FIG. 2).

The following operation and effects in addition to those of the structure of the first mode of embodiment (FIG. 2) can be obtained in the above-described structures of the second mode of embodiment to the fourth mode of embodiment shown in FIG. 3 to FIG. 5.

(1) The main frames 10B, 10C, 10D of different specifications can be formed by only replacing an arbitrary module out of such modules 11, 20A, 30A, 40A as constitute the main frame 10A (FIG. 2) in the first mode of embodiment with modules 20B, 30B, 40B of different specifications.

(2) The results of (1) above show that a group of construction machines of, for example, an equal vehicle class may have a main frame of a substantially equal strength. Therefore, it becomes possible to use in common each module of the main frames of various specifications in a group of construction machines of an equal vehicle class. This enables the cost of manufacturing the main frame to be reduced.

(3) The results of (1) show that a main frame of special specifications in little demand can also be obtained easily and inexpensively by changing a certain module only to a module of special specifications in the same manner.

The methods of manufacturing main frame structures in the second mode of embodiment to the fourth mode of embodiment described with reference to FIG. 3 to FIG. 5 can obtain the following operation and effects in addition to those of the method in the first mode of embodiment (FIG. 2).

(1) It becomes possible to use in common each module of the main frames 10A, 10B, 10C, 10D of various specifications in, for example, a group of construction machines of an equal vehicle class, and, moreover, store temporarily each of the modules in a separate machining completed state.

(2) Owing to the results of (1) above, it becomes possible to manufacture ordered main frames of various specifications in the shortest period of time, and thereby reduce the term of manufacturing the main frames.

(3) Owing to the effects described in (1) and (2) above, it becomes possible to control the quantity of production of each module and the quantity of stock thereof, and this enables the quantity of preparation of the modules to be minimized.

(4) Owing to the result of (3) above, it becomes possible to further reduce the manufacturing cost of the main frame.

(5) The main frames of special specifications in little demand can also be obtained speedily and inexpensively by replacing a certain module only with a module of special specifications.

In the methods of manufacturing main frame structures in the first mode of embodiment to the fourth mode of embodiment (FIG. 2 to FIG. 5), all the main frames 10A, 10B, 10B, 10C, 10D are manufactured by completing the machine work for each of the modules 11, 20A, 20B, 30A, 30B, 40A, 40B which constitute these main frames, and thereafter combining together required modules among these modules. The method of the present invention is not limited to such a method. The main frames may also be manufactured by combining required modules together without carrying out the whole or a part of machine work needed therefor, and thereafter subjecting the combined modules to the machine work to obtain the main frames 10A, 10B, 10C, 10D. In such a case, in the stage of the completion of the combining of an arbitrary number of modules, arbitrary portions of the modules may be subjected to machine work.

In the above-described structures in the first mode of embodiment to the fourth mode of embodiment (FIG. 2 to FIG. 5), another member, such as a reinforcing member and/or a screw hole-carrying seat plate (neither of them is shown) maybe fixed by welding to the unitary casting modules 20A, 20B, 40A, 40B in the same manner as the reinforcing members 41, 42 (FIG. 2 to FIG. 5) shown as examples in the same modules 40A, 40B.

Consequently, the invention can provide a main frame structure for construction machines, having a main frame provided in a central portion of a vehicle so as to extend in the longitudinal direction thereof, traveling units attached to the left and right sides of the main frame, and a working machine attached to a front portion and/or a rear portion of the main frame, wherein stress concentration does not occur, whereby a high durability is attained; and a method of manufacturing the same main frame structure for construction machines, capable of manufacturing the main frame structures easily, whereby a low manufacturing cost is attained.

The above is a description of the modes of embodiment of the main frame structure for construction machines and a method of manufacturing the main frame according to the present invention with a bulldozer taken as an example to which the main frame is applied but the construction machine to which the main frame is applied is not limited to a bulldozer. The main frame can be used in practice universally in the same manner as in the above-described embodiments in other construction machines, and the same operation and effects as in the above-described embodiments can be obtained.

1. A structure of a construction machine comprising:
a main frame provided in a central portion of the construction machine and extending in the longitudinal direction of the construction machine,
traveling units attached to left and right sides of the main frame, and
a working machine attached to a front portion and/or a rear portion of the main frame,
wherein a portion of the main frame to which an external force is applied by the traveling units and the working machine is formed from a unitary casting module, another portion of the main frame is formed from a sheeted module, and these modules are combined together to form the main frame.

2. The structure of a construction machine according to claim 1, wherein at least one module out of the modules constituting the main frame is formed so that the module can be selected from modules of a plurality of kinds of specifications to form main frames with different specifications.

3. A method of manufacturing a structure of a construction machine having a main frame provided in a central portion of the construction machine and extending in the longitudinal direction of the construction machine, traveling units attached to left and right sides of the main frame, and a working machine attached to a front portion and/or a rear portion of the main frame, comprising:
forming a portion of the main frame to which an external force is applied by the traveling units and working machine from a unitary casting module;
forming another portion of the main frame from a sheeted module;
processing the unitary casting and sheeting modules by machine working; and
combining the unitary casting and sheeting modules together to form the main frame.

4. The method of manufacturing a structure of a construction machine according to claim 3, wherein at least one module out of the modules to which a required machine work is separately completed can be selected from modules of a plurality of kinds of specifications to manufacture main frames with different specifications.
